(19) United States
(12) Patent Application Publication
(10) Pub. No.: US 2020/0292370 A1
(43) Pub. Date: Sep. 17, 2020

(54) METHOD AND APPARATUS FOR ILLUMINATING THE INTERIOR OF A VESSEL TO DETERMINE THE FILL LEVEL THEREOF

(71) Applicant: Sysco Guest Supply, LLC, Somerset, NJ (US)

(72) Inventor: Joungsu Park, South Brunswick, NJ (US)

(73) Assignee: Sysco Guest Supply, LLC, Somerset, NJ (US)

(21) Appl. No.: 16/351,336

(22) Filed: Mar. 12, 2019

(51) Int. Cl. G01F 23/292; B60R 1/12

(52) U.S. Cl. CPC G01F 23/2928; B05B 11/3001; B60R 1/1207

(57) ABSTRACT

A refillable vessel uses light from an external source such as a portable LED flashlight to illuminate the interior of the vessel to determine the level of the vessel contents without the need for separate sight windows in the wall(s) of the vessel. At least the sidewall of the vessel incorporates a one-way or “semi-silvered” mirror that visually obscures the contents of the vessel until illuminated with the external light source. The one-way mirror is preferably implemented with a metallized film. A portion of the bottom of the vessel may be used for illuminating the interior of the vessel. The vessel may be supported in a bracket with an opening that aligns with an illumination region, window or port. The contents of the vessel may include a liquid, a cream, or a gel comprising a personal hygiene product used in the hospitality industry, for example.

### FIELD OF THE INVENTION

This invention relates generally to containers, dispensers, and the like and, more particularly, to a method and apparatus for illuminating the interior of a container to determine fill level.

### BACKGROUND OF THE INVENTION

In many industries, containers, dispensers and other vessels are mounted or left in a particular location, yet require refilling when their contents are depleted. One such industry is the hospitality industry, which includes hotel/motel lodging, conference and event venues, travelling and additional fields within the tourism industry.

With respect to lodging in particular, it is now a common practice to provide containers and dispensers in rooms for guest use. Such containers and dispensers, often wall-mounted, may contain liquid soaps, shampoos, cream and other hygiene products. As these substances are used, it is important for the service staff to ensure that the containers are refilled to avoid complaints.

One way to easily determine fill level is to provide transparent or translucent vessels so that the fill level is immediately apparent. However, this may make the container or dispenser unsightly, as the obvious fill line may interfere with the appearance of the product or obscure desired labeling, packaging or instruction details.

An alternative to the use of a fully transparent or translucent container is to incorporate a transparent or translucent “sight window” on the container to determine fill level. This technique is used on some plastic motor oil containers in the form of a vertical translucent strip that runs up the side of the container.

Sight windows are also used on some wall-mounted containers in the hospitality industry. One example is disclosed in U.S. Pat. No. 7,066,357, entitled WALL-MOUNTED DISPENSER ASSEMBLY WITH TRANSPARENT WINDOW. However, even the dispenser in this instance anticipates the use of a transparent container. More particularly, this prior art reference contemplates the use of a sight window in conjunction with a much larger light window at the top of cover to admit greater amounts of light to the inside of the container when the cover is in the closed position. This purportedly enables enhanced viewing through the sight window as well as viewing through the window. “Such an arrangement is particularly advantageous when the container itself is fabricated from clear material.”

Given the undesirable appearance of clear containers in the hospitality industry and other fields of use, the need remains for a refillable container, dispenser or other vessel that can be surreptitiously interrogated to determine fill level without the use of sight windows.

### SUMMARY OF THE INVENTION

In broad and general terms, this invention resides in a vessel that uses light from an external source to illuminate the interior of the vessel to determine the level of vessel contents without the need for separate sight windows in the wall(s) of the vessel. The vessel may be a refillable vessel, and the external light source may be a flashlight.

The vessel comprises a top portion, a bottom portion, and a sidewall extending from the top portion to the bottom portion. At least the sidewall of the vessel incorporates a one-way mirror that visually obscures the contents of the vessel in ambient light conditions. However, when light from an external source enters into the vessel and illuminates the interior of the vessel, the fill level of the contents of the vessel becomes visible through the one-way mirror. The external source of light is preferably a portable, hand-held LED flashlight.

The vessel may be constructed from any suitable material such as glass or plastic. In the preferred embodiment, the one-way mirror is implemented with a metallized film or coating that covers at least the sidewall of the vessel. A portion of the vessel such as a portion of the bottom of the vessel may not include the one-way mirror, thereby forming a transparent or translucent window through which the interior of the vessel may be more readily illuminated.

The vessel may be received by a wall-mounted bracket including an opening that aligns with a light-receiving region or area in the vessel. For example, a portion of the bottom of the vessel may include a transparent or translucent window in alignment with a hole in the bracket, enabling the interior of the vessel to be illuminated from the bottom up. Conveniently, the hole in the bracket may form part of a drainage opening.

The vessel may be dispenser received by a wall-mounted bracket, in which case the top portion of the vessel may include a manually operated pump. The contents of the vessel may include a liquid, a cream, or a gel, such as a personal hygiene product which could include, without limitation, shampoos, conditioners, shower gels, soaps or cleansers, hand or body lotions or creams, sanitizers, oral hygiene or shaving products.

### BRIEF DESCRIPTION OF THE DRAWINGS

FIG. 1A shows a vessel according to the invention prior to external illumination;

FIG. 1B shows the vessel of FIG. 1A being illuminated with a pocket-sized LED flashlight to reveal a vessel fill level; and

FIG. 2 is a bottom view of a bracket including drainage openings through which the interior of a vessel may be illuminated.

### DETAILED DESCRIPTION OF THE PREFERRED EMBODIMENTS

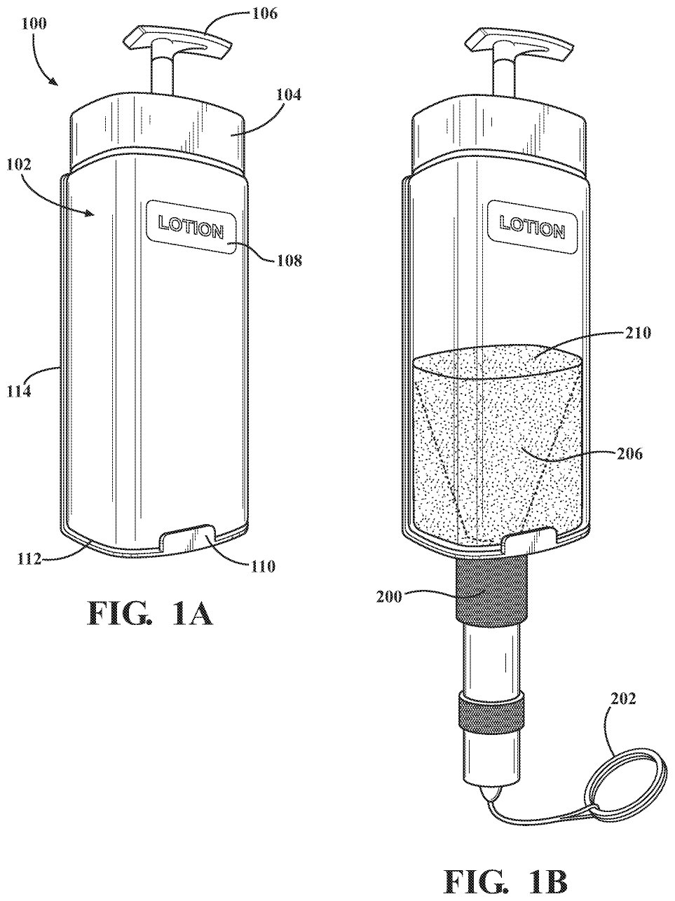

In broad and general terms, this invention uses an externally supplied light source to illuminate the inside of a vessel to reveal at least the fill level of the contents therein. FIG. 1A shows a vessel 100 according to the invention prior to illumination, and FIG. 1B shows the vessel of FIG. 1A being illuminated to reveal the fill level.

The vessel 100 in FIGS. 1A, B, is a wall-mounted lotion dispenser mounted on a bracket 114 having a bottom portion 112 with a retaining lip 110. The vessel 100 in this case includes a body portion with a sidewall 102, and a top portion with a cap 104 including a manually operated pump 106. However, this embodiment is exemplary only, insofar as the invention is not limited in terms of the vessel type, which may include bottles, jars, tubes, containers, dispensers, and so forth. As such, as used herein, the word “vessel” should be taken to include all of these various configurations, regardless of container type or shape or brackets for mounting.

Nor is the invention limited in terms of vessel contents, which may include any liquid, preferably light-permeable liquids, ranging from highly viscous creams and gels to very watery fluids. As such, the invention is applicable to any suitable hygiene products including, without limitation, shampoos, conditioners, shower gels, soaps or cleansers, hand or body lotions or creams, sanitizers oral hygiene and shaving products. The invention may also be used in conjunction with consumable liquids including water, soft drinks, and so forth.

In accordance with the invention, at least the sidewall of the vessel includes a “one-way mirror” (sometimes referred to as a “two-way mirror”). As such, prior to illumination, the vessel intentionally appears to be a sealed metal or metallic container.

The one-way mirror may be implemented in any manner, including a spray-on coating or with substances embedded within the walls of the container. In the preferred embodiment, however, a metallized, metallic or “semi-silvered” mirrored film is applied onto or over at least the sidewall of the vessel. The film may be permanently bonded to the vessel through heat and/or adhesive(s), or the vessel may be shaped to retain the film in a desired position; i.e., the film may be in the form of a sleeve that is trapped by structures on or in the vessel. Alternatively, the film may be shrink-wrapped onto the vessel. Decorative textual or graphical elements 108 may be applied in any suitable manner, including printed onto the mirrored film or printed onto a transparent, translucent or opaque adhesive label.

Various one-way films may be used, including thermoplastic PETG films that can be injection molded, sheet extruded and colored during processing. Films of this type may be sold under the name Mylar. A preferred film thickness is in the range of 1.9 to 2 mil, with a preferred opacity in the range of 80% to 100%. In use, the film is highly reflective without back-illumination, thereby obscuring the contents of the vessel under normal ambient-light conditions, while becoming more light transmissive, and at least semi-transparent or translucent when back-illuminated to facilitate temporary fill level visualization.

Thus, the film is “light reactive” in the sense that the film transitions from reflective to translucent when illuminated as described herein. As shown in FIG. 1B, a preferred method of providing external illumination is through the use of an inexpensive, portable LED flashlight 200 that may conveniently be carried on a key ring 202. The light from the flashlight 200 may be any color, but is preferably white. The invention is not limited in terms of the portable light source used, which may include smartphone flashlights. When the flashlight is activated, it creates a beam 206 though the contents of the vessel, causing the fill level 210 to be visually apparent through the mirrored sidewall of the vessel.

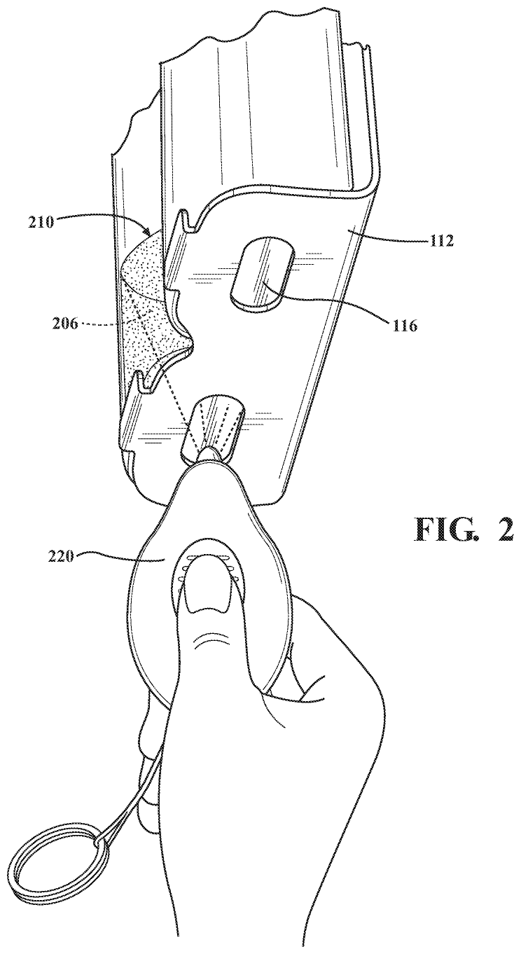

The vessel may be supported in a wall-mounted bracket 114, which may include a bottom 112 with a retainer lip 110. To facilitate bottom's-up illumination, the bracket may include port(s) 116 through the bracket and underneath each vessel, as shown in FIG. 2. Such ports may already be provided in such brackets in the form of ‘drainage holes’ to alleviate excess moisture build-up under the vessels.

FIG. 2 further shows a pushbutton flashlight 220 positioned below a container and shined upwardly through such a drainage hole 116 in the bottom 112 of the wall-mounting bracket 114. This causes the beam 206 to shine through the contents of the vessel, further causing the fill level 210 to be visibly apparent through the sidewall(s) of the vessel. Particularly if a portion of the bottom of the vessel does not include the one-way mirroring, the vessel contents and fill level become visually apparent upon illuminating. Even if the bottom is also mirrored, if the light source is strong enough, the fill level should still be evident. With an even stronger light source, the fill level may be visible by directing the light through the mirrored sidewall of the vessel.

Different types of materials may be used to form the vessel, including plastics with polyethylene formulations, polycarbonates, silicones, glass, and so forth. The invention is not limited in terms of the type of material used as long as the vessel-mirror combination allows the fill level to be visibly evident through the sidewall when illuminated as disclosed herein. As such, the vessel walls should be at least translucent or transparent prior to the including of the one-way mirror substance or film. The top portion(s) of the vessel, for example the cap 104 and pump 106, need not be translucent or transparent, and in fact may be opaque.

1. Apparatus for determining the content fill level of a vessel, comprising:
a fillable vessel including an interior defined by a top portion, a bottom portion, and a sidewall extending from the top portion to the bottom portion;
wherein at least the sidewall of the vessel incorporates a one-way mirror that visually obscures the contents of the vessel; and
wherein the vessel includes a region adapted to receive light from an external source to illuminate the interior of the vessel, such that, upon receiving the external illumination, the content fill level of the vessel becomes visibly apparent through the sidewall.

2. The apparatus of claim 1, wherein the one-way mirror is implemented with a substance embedded in the sidewall of the vessel.

3. The apparatus of claim 1, wherein the one-way mirror is implemented with a metallized coating.

4. The apparatus of claim 1, wherein the one-way mirror is implemented with a metallized film.

5. The apparatus of claim 1, wherein the region adapted to receive light from an external source includes a portion of the bottom of the vessel.

6. The apparatus of claim 1, wherein the region adapted to receive light from an external source is translucent or transparent.

7. The apparatus of claim 1, wherein the region adapted to receive light from an external source does not include a one-way mirror.

8. The apparatus of claim 1, wherein the vessel is a refillable vessel.

9. The apparatus of claim 1, wherein the vessel includes a manually operated pump.

10. The apparatus of claim 1, further including a bracket to receive the vessel.

11. The apparatus of claim 10, wherein the bracket is a wall-mounted bracket.

12. The apparatus of claim 10, wherein the bracket includes an opening in alignment with the region of the vessel adapted to receive light from an external source.

13. The apparatus of claim 12, wherein the bracket includes a drainage opening in alignment with a region on the bottom of the vessel adapted to receive light from an external source.

14. The apparatus of claim 1, wherein the external source of light is an LED flashlight.

15. The apparatus of claim 1, wherein the contents includes a liquid, a cream, or a gel.

16. The apparatus of claim 15, wherein the liquid, a cream, or gel is a personal hygiene product.

17. The apparatus of claim 16, wherein the personal hygiene product is a shampoo, conditioner, shower gel, soap or cleanser, hand or body lotion or cream, skin sanitizer, or oral hygiene or shaving product.

18. A method of determining the content fill level of a vessel, comprising the steps of:
providing a vessel including a sidewall incorporating a one-way mirror that visually obscures the contents of the vessel; and
illuminating the interior of the vessel with an external light source such that the fill level of the contents becomes visually apparent through the one-way mirror.

19. The method of claim 18, wherein the step of illuminating the interior of the vessel includes illuminating the interior with a flashlight.
